(19) United States
(12) Patent Application Publication
(10) Pub. No.: US 2026/0205375 A1
(43) Pub. Date: Jul. 16, 2026

(54) SERVICE IMPLEMENTATION METHOD AND DEVICE, AND STORAGE MEDIUM

(71) Applicants: China Mobile Communication Co., Ltd Research Institute, Beijing (CN); China Mobile Communications Group Co., Ltd., Beijing (CN)

(72) Inventors: Junlan FENG, Beijing (CN); Zhijie REN, Beijing (CN); Chao DENG, Beijing (CN); Xiangyang YUAN, Beijing (CN); Di JIN, Beijing (CN); Shilei ZHANG, Beijing (CN)

(21) Appl. No.: 19/136,382

(22) PCT Filed: Dec. 26, 2023
(86) PCT No.: PCT/CN2023/142052

§ 371 Date: Jun. 6, 2025

(30) Foreign Application Priority Data
Dec. 27, 2022 (CN) 202211687334.1

(51) Int. Cl. H04L 41/16

(52) U.S. Cl. CPC H04L 41/16

(57) ABSTRACT

A service implementation method and device, and a storage medium are provided in the present disclosure. The method includes: querying a preset knowledge base according to a target service requirement to determine an AI atomized capability type sequence corresponding to the target service requirement; querying a preset capability database according to the AI atomized capability type sequence to determine a target AI atomized capability set required to implement the service requirement; building an end-to-end AI service application based on the target AI atomized capability set.

### CROSS-REFERENCE TO RELATED APPLICATION

The present application is filed based on and claims the priority of Chinese Application No. 202211687334.1 filed on Dec. 27, 2022, entitled “service implementation method, device and storage medium”, the disclosure of which are incorporated in their entireties by reference herein.

### TECHNICAL FIELD

The present disclosure relates to the field of artificial intelligence technologies, and in particular to a service implementation method, device and storage medium.

### BACKGROUND

Artificial intelligence (AI) technology is widely used in all industries to solve various tasks, such as speech recognition, image recognition, machine translation, which have reached or exceeded human capabilities. Artificial intelligence platforms further play the role of sharing data, computing power, and capabilities, accelerating the application of artificial intelligence technology. However, with continuous enrichment of service scenarios, an AI model that solve a single problem is difficult to meet application needs.

### SUMMARY

In view of this, an object of the present disclosure is to provide a service implementation method, device and storage medium.

In order to achieve the above object, the technical solution of the present disclosure is as follows.

One embodiment of the present disclosure provides a service implementation method, including:
querying a preset knowledge base according to a target service requirement to determine an AI atomized capability type sequence corresponding to the target service requirement;
querying a preset capability database according to the AI atomized capability type sequence to determine a target AI atomized capability set required to implement the service requirement;
building an end-to-end AI service application based on the target AI atomized capability set.

In the above solution, the method further includes:
obtaining at least one AI atomized capability corresponding to each AI capability in at least one AI capability; wherein the at least one AI atomized capability corresponding to each AI capability is obtained by reconstructing the AI capability; and
constructing a capability database according to the at least one AI atomized capability corresponding to each AI capability.

In the above solution, the reconstructing the AI capability, includes at least one of the following:
decomposing the AI capability into a combination of AI atomized capabilities, and determining a general intelligence layer, adaptation layer, interface layer and capability information included in each AI atomized capability; wherein the capability information at least includes an adaptation layer parameter;
decomposing computing network resources required for the AI capability, determining a computing network resource requirement corresponding to each AI atomized capability, and establishing correspondence between the adaptation layer parameter of each AI atomized capability and the computing network resource requirement.

In the above solution, the querying a preset capability database according to the AI atomized capability type sequence to determine a target AI atomized capability set required to implement the service requirement, includes:
querying the capability database according to the AI atomized capability type sequence to determine at least one AI atomized capability set; constructing a loss function according to service input data, adaptation layer parameter and actual service data of AI atomized capabilities in each AI atomized capability set;
with a goal of minimizing the loss function, optimizing the adaptation layer parameters of at least one AI atomized capability set to determine the target AI atomized capability set.

In the above solution, the building an end-to-end AI service application based on the target AI atomized capability set, includes:
determining a collection end of service data and a receiving end of a service data processing result;
determining a data flow network transmission path from the collection end to the receiving end;
based on the principle of fastest calculation, according to network node information and location information in the data flow network transmission path, determining a network node set required for deploying the target AI atomized capability set;
deploying corresponding AI atomized capabilities on each network node in the network node set to build the end-to-end AI service application.

In the above solution, the method further includes:
according to feedback data of the end-to-end AI service application, dynamically adjusting the adaptation layer parameter of the AI atomized capability and/or an AI model corresponding to the AI atomized capability.

In the above solution, according to feedback data of the end-to-end AI service application, dynamically adjusting the adaptation layer parameter of the AI atomized capability, includes:
obtaining feedback data of the end-to-end AI service application, updating the loss function according to the feedback data and the adaptation layer parameter; wherein the feedback data includes service input data and user feedback service data;
optimizing adaptation layer parameters for at least one AI atomized capability set with the goal of minimizing the updated loss function, and determining a new target AI atomized capability set.

In the above solution, according to feedback data of the end-to-end AI service application, dynamically adjusting an AI model corresponding to the AI atomized capability, includes:
obtaining feedback data of the end-to-end AI service application, and optimizing the AI model corresponding to at least one target AI atomized capability according to the feedback data.

In the above solution, the deploying corresponding AI atomized capabilities on each network node in the network node set, includes:
according to a preset deployment protocol, deploying corresponding AI atomized capabilities on each network node in the network node set; wherein the deployment protocol includes at least one of the following:
a distribution protocol configured to indicate interactive operations between network nodes during a process of the AI capability accessing the network;
a security protocol configured to indicate encryption and decryption operations and/or protection operations between network nodes.

One embodiment of the present disclosure provides a service implementation device, including:
a first processing module configured to query a preset knowledge base according to a target service requirement to determine an AI atomized capability type sequence corresponding to the target service requirement;
a second processing module configured to query a preset capability database according to the AI atomized capability type sequence to determine a target AI atomized capability set required to implement the service requirement;
a third processing module configured to build an end-to-end AI service application according to the target AI atomized capability set.

In the above solution, the device further includes a construction module configured to obtain at least one AI atomized capability corresponding to each AI capability in at least one AI capability; wherein the at least one AI atomized capability corresponding to each AI capability is obtained by reconstructing the AI capability; and construct a capability database according to the at least one AI atomized capability corresponding to each AI capability.

In the above solution, the construction module is configured to perform at least one of the following:
decomposing the AI capability into a combination of AI atomized capabilities, and determining a general intelligence layer, adaptation layer, interface layer and capability information included in each AI atomized capability; wherein the capability information at least includes an adaptation layer parameter;
decomposing computing network resources required for the AI capability, determining a computing network resource requirement corresponding to each AI atomized capability, and establishing correspondence between the adaptation layer parameter of each AI atomized capability and the computing network resource requirement.

In the above solution, the second processing module is configured to: query the capability database according to the AI atomized capability type sequence to determine at least one AI atomized capability set; construct a loss function according to service input data, adaptation layer parameter and actual service data of AI atomized capabilities in each AI atomized capability set; with a goal of minimizing the loss function, optimize the adaptation layer parameters of at least one AI atomized capability set to determine the target AI atomized capability set.

In the above solution, the third processing module is configured to: determine a collection end of service data and a receiving end of a service data processing result;
determine a data flow network transmission path from the collection end to the receiving end;
based on the principle of fastest calculation, according to network node information and location information in the data flow network transmission path, determine a network node set required for deploying the target AI atomized capability set;
deploy corresponding AI atomized capabilities on each network node in the network node set to build the end-to-end AI service application.

In the above solution, the device further includes: an optimization module configured to, according to feedback data of the end-to-end AI service application, dynamically adjust the adaptation layer parameter of the AI atomized capability and/or an AI model corresponding to the AI atomized capability.

In the above solution, the optimization module is configured to obtain feedback data of the end-to-end AI service application, update the loss function according to the feedback data and the adaptation layer parameter; wherein the feedback data includes service input data and user feedback service data; optimize adaptation layer parameters for at least one AI atomized capability set with the goal of minimizing the updated loss function, and determining a new target AI atomized capability set.

In the above solution, the optimization module is configured to obtain feedback data of the end-to-end AI service application, and optimizing the AI model corresponding to at least one target AI atomized capability according to the feedback data.

In the above solution, the third processing module is configured to, according to a preset deployment protocol, deploy corresponding AI atomized capabilities on each network node in the network node set; wherein the deployment protocol includes at least one of the following:
a distribution protocol configured to indicate interactive operations between network nodes during a process of the AI capability accessing the network;
a security protocol configured to indicate encryption and decryption operations and/or protection operations between network nodes.

One embodiment of the present disclosure provides a service implementation device, including: a memory, a processor and a computer program stored in the memory and executable on the processor; wherein the processor, when executing the program, performs the steps of the above service implementation method.

One embodiment of the present disclosure provides a computer-readable storage medium, including a computer program stored thereon; wherein the computer program, when executed by a processor, causes the processor to perform the steps of the above service implementation method.

According to the service implementation method, device, and storage medium provided in the embodiments of the present disclosure, the method includes: querying a preset knowledge base according to a target service requirement to determine an AI atomized capability type sequence corresponding to the target service requirement; querying a preset capability database according to the AI atomized capability type sequence to determine a target AI atomized capability set required to implement the service requirement; building an end-to-end AI service application based on the target AI atomized capability set. According to the technical solution provided in the embodiments of the present disclosure, a targeted AI atomized capability type sequence is determined according to service requirements, and then the target AI atomized capability set for implementing the service requirement is determined based on the AI atomized capability type sequence, thereby achieving effects of on-demand selecting AI atomized capabilities and providing targeted AI service applications.

### BRIEF DESCRIPTION OF THE DRAWINGS

FIG. 1 is a schematic flow chart of a service implementation method according to an embodiment of the present disclosure;

FIG. 2 is a schematic flow chart of an exemplary end-to-end service implementation method of a network complaint self-service robot according to an embodiment of the present disclosure;

FIG. 3 is a schematic diagram of an exemplary holistic intelligent system according to an embodiment of the present disclosure;

FIG. 4 is a schematic diagram of a service implementation device according to an embodiment of the present disclosure; and

FIG. 5 is a schematic diagram of another service implementation device according to an embodiment of the present disclosure.

### DETAILED DESCRIPTION

Before further describing the present disclosure in detail with reference to the embodiments, the related art will be described first.

Machine learning is the science of studying how to use computers to simulate or realize human learning activities. Traditional machine learning includes decision trees, random forests, artificial neural networks, Bayesian learning, support vector machines, etc., which obtain the best representation of historical data by finding an optimal mathematical function. The traditional machine learning process generally includes data, model, loss function, optimization, tuning, result analysis, deployment and operation stages. The data stage is mainly to obtain data and process data, including data cleaning and feature processing. The model stage is mainly to select a basic model based on the problem and data, such as whether to use a decision tree model or a support vector machine model. The loss function is a measure of model accuracy, and the purpose of machine learning is to minimize the loss function. The optimization process refers to the process of minimizing the loss function using the processed historical data and the gradient method. The tuning process refers to adjusting the hyperparameters of the model, such as the number of trees in the decision tree, the penalty factor C and the kernel function parameter G in the support vector machine. The result analysis process is to compare the model accuracy and running time. Algorithm expansion is to verify the generalization of the model on the validation set. Deployment and operation mainly involve deploying the models obtained through machine learning to actual production application systems to ensure their real-time, stability, and scalability.

Deep learning is to obtain historical data's intrinsic patterns and representation hierarchies by combining low-level features to form more abstract high-level representation features, thereby achieving mechanisms to imitate the human brain to interpret data, such as images, speech, text, etc. A general deep learning structure includes an input layer, a hidden layer and an output layer. Deep learning process is to select suitable input layer and output layer, design suitable neuron computation node and multi-layer network structure, and establish functional relationship from input to output through backpropagation algorithm. A basic deep learning model includes deep neural network (DNN), convolutional neural network (CNN), recurrent neural network (RNN), etc. With development of big data and high-performance computing power, deep learning technology has become the mainstream algorithm technology of current artificial intelligence technology. At present, many classic network structures and pre-trained models have also been developed, such as AlexNet, VGG-16/19, GoogLeNet/Inception, ResNet, MobileNet, Bert, GPT-3, etc.

Automatic machine learning is to simplify the model training process in machine learning and improves modeling efficiency by automating some common machine learning steps (such as data preprocessing, model selection, and hyperparameter optimization). The specific process includes automatic data preparation, automatic feature extraction, automatic algorithm selection, hyperparameter optimization, automatic pipeline/workflow construction, neural network architecture search, automatic model selection, and ensemble learning. Depending on different data tasks to be solved, the commonly used automatic machine learning include AutoML, AutoCV, and AutoNLP. The purpose of automatic machine learning is to achieve automatic model selection, automatic network design and parameter optimization through hyperparameter optimization method.

Artificial Intelligence (AI) capabilities mainly refers to natural language and intelligent speech, and includes five core technologies: natural language processing, intelligent speech, machine vision, data analysis and decision-making, and knowledge graphs. The natural language processing includes capabilities such as entity recognition, text classification, summary generation, text generation, and human-computer dialogue. The intelligent speech technology includes capabilities such as speech recognition, speech synthesis, and voiceprint recognition. The machine vision mainly uses computers to simulate human visual functions, including image classification, object recognition, semantic segmentation, and face detection. The data analysis and decision-making refers to using appropriate statistical analysis methods to analyze, summarize, and understand large amounts of data to play the role of data, and the most typical capability is data mining. The knowledge graphs describe concepts, entities, and their relationships in the objective world in a structured form, provides an ability to organize, manage and understand massive amounts of information, and is a key technology that promotes machines to have cognitive intelligence.

AI computing power refers to all hardware devices that can be used for computing, including but not limited to AI-specific computing chips such as graphics processing units (GPUs), tensor processing units (TPUs), data processing units (DPUs), etc., and traditional computing devices such as cloud server devices, terminal devices, network devices, etc. The AI computing process includes but is not limited to data clearing, feature extraction, model training, model reasoning, etc.

AI application refers to integration of artificial intelligence technology with various industries and its use in specific service systems, and is the most direct manifestation of the value of artificial intelligence technology. Artificial intelligence technology has been applied to all aspects of production and life. A typical service system using artificial intelligence technology includes cascade or parallel connection of multiple AI capabilities.

AI platform refers to a platform that is compatible with a variety of AI computing hardware, adapts to a variety of mainstream AI frameworks, algorithm models, data processing technologies, etc., supports a variety of reasoning and training cloud services such as structured data, vision, speech and natural language processing, and supports the full life cycle management of AI capabilities from training, deployment, to reasoning.

Communication network is a pipeline for information flow, which connects various elements required for artificial intelligence, including service data, AI computing power, and AI capabilities.

In related art, the AI technology has reached or exceeded human capabilities in solving many single-scenario tasks, such as speech recognition, image recognition, and machine translation. The AI platform further plays a role in sharing data, computing power, and capabilities, accelerating the application of artificial intelligence technology. However, the AI technology in related art still has the following problems.

First, AI capabilities based on existing technologies are achieved mainly by optimizing a single problem goal in a static environment. For example, speech recognition uses annotated public data sets or offline service data sets to train and optimize the model, with an optimization goal of minimizing word error rate. Similarly, the optimization goal of image recognition is to improve recognition accuracy, and the goal of machine translation is to improve translation accuracy. In actual service applications, multiple AI capabilities need to be connected in series or in parallel to build an end-to-end service system. When multiple AI capabilities are connected to a dynamic service system through engineering, on the one hand, data distribution in an open service system is different from that in the static environment. On the other hand, the service process is a cascade or parallel process. After being connected together through engineering, optimization and improvement of a single AI capability cannot bring about performance improvement of the end-to-end service. The existing technical solutions cannot achieve end-to-end closed-loop optimization for cascaded multiple AI capabilities aligned with service objectives.

Second, with the maturation of AI technology, its applicable service scenarios have expanded significantly. However, models developed through current AI technology exhibit insufficient generalization, necessitating complete retraining when applied to new application areas and service data. Taking text sentiment classification as an example, for different service scenarios such as government projects, hotline complaints, and message secretaries, model training needs to be carried out separately to meet the service requirements for model performance, and the cost of scenario-based intelligent training is high.

Third, the existing AI platform, as a middle platform for AI cloud-edge training and reasoning, can gather excellent AI capabilities on the one hand, and realize data transmission and capability call between single AI capability and applications on the other hand, but it cannot automatically cascade or parallel the required AI capabilities according to service needs to build an end-to-end AI service service system. In addition, to ensure the normal operation of the service, the artificial intelligence platform will prepare sufficient computing resources for each service of each user in advance, and cannot dynamically allocate and elastically scale computing resources according to actual service needs.

Fourth, as an information service technology, AI technology's data transmission, capability call, and cloud-edge-terminal computing power collaboration are all required to be integrated into communication networks. However, current communication network technologies are mainly serving information transmission, and are still unable to distribute network-connected AI capabilities, control and manage AI services and AI on-network computing, unable to provide unified, integrated AI capabilities, computing power, networks of orchestration, control and scheduling.

The above problems have resulted in that the current cost-benefit ratio of AI-enabled industries remains high, and the intelligent transformation of many industries and institutions has been slow.

In view of this, a method provided in one embodiment of the present disclosure includes: querying a preset knowledge base according to a target service requirement to determine an AI atomized capability type sequence corresponding to the target service requirement; querying a preset capability database according to the AI atomized capability type sequence to determine a target AI atomized capability set required to implement the service requirement; and building an end-to-end AI service application based on the target AI atomized capability set.

The present disclosure will be further described in detail hereinafter in conjunction with the embodiments.

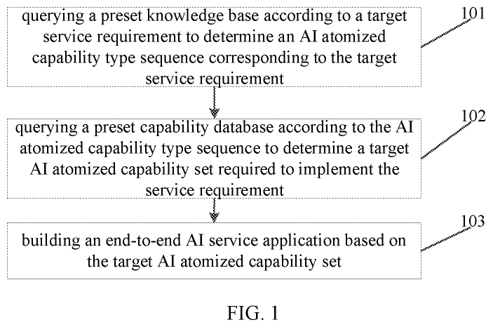

A service implementation method according to one embodiment of the present disclosure can be applied to an intelligent device, such as a server, computer and other devices. FIG. 1 is a schematic flow chart of a service implementation method according to an embodiment of the present disclosure. As shown in FIG. 1, the service implementation method includes:
Step 101: querying a preset knowledge base according to a target service requirement to determine an AI atomized capability type sequence corresponding to the target service requirement;
Step 102: querying a preset capability database according to the AI atomized capability type sequence to determine a target AI atomized capability set required to implement the service requirement;
Step 103: building an end-to-end AI service application based on the target AI atomized capability set.

In actual application, if one AI model can be shared by multiple AI capabilities or multiple servicees, it can reduce the training cost of the AI model and improve the utilization rate of the AI model. Therefore, AI capability reconstruction is proposed to obtain multiple AI atomized capabilities for sharing by multiple AI capabilities and multiple servicees.

Based on this, in some embodiments, the service implementation method further includes: obtaining at least one AI atomized capability corresponding to each AI capability in at least one AI capability; where the at least one AI atomized capability corresponding to each AI capability is obtained by reconstructing the AI capability; and constructing a capability database according to the at least one AI atomized capability corresponding to each AI capability.

Here, the AI capability refers to a combined capability formed by connecting multiple AI atomized capabilities in series in a specific application scenario or workflow, to address a specific problem.

The AI atomized capability (also called atomized AI capability) refers to an AI capability to complete a specific task that cannot be further subdivided.

By reconstructing (also called decomposing) AI capability, at least one AI atomized capability can be obtained. It is to be noted that the reconstruction of AI capability can be done in advance by a capability provider and provided to a smart device. A granularity of the AI capability atomized decomposition is determined by the capability provider, as long as the decomposed AI atomized capability meets standards of holistic organization; and each AI atomized capability can be self-closed-loop optimized, that is, it is a capability that can be trained and optimized separately.

In some embodiments, reconstructing the AI capability includes at least one of the following:
decomposing the AI capability into a combination of AI atomized capabilities, and determining a general intelligence layer, adaptation layer, interface layer and capability information included in each AI atomized capability; where the capability information at least includes an adaptation layer parameter;
decomposing computing network resources required for the AI capability, determining a computing network resource requirement corresponding to each AI atomized capability, and establishing correspondence between the adaptation layer parameter of each AI atomized capability and the computing network resource requirement.

By reconstructing the AI capabilities provided by the holistic AI system, a capability database is obtained. The capability database includes: at least one AI capability and an AI atomized capability combination corresponding to each AI capability; the AI atomized capability combination includes one or more AI atomized capabilities and capability information corresponding to each AI atomized capability.

Here, the capability information may include: capability description information of AI atomized capability, computing network resource requirement, adaptation layer parameter, correspondence between adaptation layer parameter and computing network resource requirement, and an identifier of AI atomized capability.

Each AI atomized capability includes: a general intelligence layer, an adaptation layer, and an interface layer. The general intelligence layer is an abstract general model part that can be applied to different servicees (i.e., sharing by multiple AI capabilities and multiple servicees). One part affected by the service is the adaptation layer, that is, the adaptation layer is an adaptation part for applying the general model to different servicees, and can be adapted and optimized according to specific service needs. The interface layer is used to connect with other models to ensure that different AI atomized capabilities can be self-organized and connected together according to standards. Taking image classification as an example, one part that extracts image features can be used as the general intelligence layer; and for different service classification requirements, a fully connected part for obtaining a classification result after feature extraction can be used as an adaptation layer, and the adaptation layer can be adapted and adjusted according to different service requirements.

Taking speech recognition capability as an example, an input of the speech recognition capability is speech signal data, and an output is speech recognition text. According to the general speech recognition process, the speech recognition capability can be divided into five AI atomized capabilities, namely speech enhancement, speech single point detection, speech feature extraction, acoustic model, and language model. Each AI atomized capability has two interface layers, one adaptation layer and one general intelligence layer. The two interface layers define the input and output of the AI atomized capability to ensure that end-to-end optimization calculations can be executed. The adaptation layer optimizes, for example, feature dimension and feature representation accuracy within open and dynamic service environment. The general intelligence layer is the core and the main body of the model, and can be shared by multiple capabilities and multiple servicees. For example, speech feature extraction can be used for speech recognition, as well as AI capabilities such as speech emotion classification and speaker recognition. The service service can be a customer complaint service or an intelligent conference service.

A specific example is provided hereinafter.

An AI capability with clear input, output and computing network resource requirement is denoted as C(I,O,G), and k(k≥1) AI atomized capabilities are obtained, denoted as: C(I,O,G)={C₁(I,A(_{w}),U,O,m),G₁,C₂(I,A(_{w}),U,O,m),G₂ . . . , Cₖ(I,A(_{w}),U,O,m),Gₖ}

Where in Ci (I,A(w),U,O,m)(i=1, 2, . . . , k), I represents an input interface (i.e., one interface layer), and O represents an output interface (i.e., another interface layer);

A(w) represents an adaptation layer, which can be adaptively adjusted and optimized according to service requirement; w is a set of hyperparameters that can be adjusted and optimized, such as fully connected layer relevant parameter.

U represents a general intelligence layer, which is the general model part that can be applied to multiple capabilities and multiple servicees.

m represents an identifier of the AI atomized capability. Multiple AI atomized capabilities with the same function have the same identifier. For example, face detection atomized capabilities provided by different AI capability providers have the same AI atomized capability identifier.

Gᵢ represents a computing network resource requirement of AI atomized capability.

That is, atomic restructuring is performed on C(I,O,G), to decompose AI capability to obtain an AI atomized capability set C, and decompose the computing network resources G required for the AI capability to obtain computing network resource requirements G₁, G₂ . . . . Gₖ of each AI atomized capability.

After atomized reconstruction, AI atomized capabilities of different AI capabilities can be recombined and optimized. For example, two speech capabilities C¹ and C² are reconstructed separately to obtain AI atomized capability sets

$${C}_{1}^{1} , {C}_{2}^{1} , {C}_{3}^{1} , {C}_{4}^{1} and {C}_{1}^{2} , {C}_{2}^{2} , {C}_{3}^{2} , {C}_{4}^{2} ,$$

which can be optimally combined into new speech recognition processes

$$( {C}_{1}^{2} , {C}_{2}^{1} , {C}_{3}^{1} , {C}_{4}^{2} )$$

based on service requirements.

The computing network resource required for the speech capability C¹ is G, and is decomposed to obtain computing network resources G₁, G₂, G₃ and G₄ required for four AI atomized capabilities.

In actual application, the AI atomized capability type sequence corresponding to various standard service requirements can be defined in advance.

Based on this, in some embodiments, the service implementation method further includes: establishing a knowledge base for atomized capability matching; where the knowledge base includes: at least one service requirement and an AI atomized capability type sequence corresponding to each service requirement.

Here, for a newly emerging service requirement, a new AI atomized capability type sequence corresponding to the new service requirement can be parsed by expert analysis or intent mining, and is added to the knowledge base for subsequent services.

For example, the knowledge base includes: network complaint self-service robot service requirement, and its corresponding AI atomized capability type sequence can include the following AI atomized capability types: speech enhancement, speech single point detection, speech feature extraction, acoustic model, language model, text segmentation, entity word recognition, keyword extraction, summary generation, root cause analysis, intelligent decision-making, and fault handling. Each AI atomized capability can have multiple AI capability providers, that is, there can be multiple AI atomized capability options for each AI atomized capability type, so that multiple AI atomized capability sets can be formed. Therefore, a best AI atomized capability set is selected based on actual service requirements.

In some embodiments, the querying a preset capability database according to the AI atomized capability type sequence to determine a target AI atomized capability set required to implement the service requirement, includes: querying the capability database according to the AI atomized capability type sequence to determine at least one AI atomized capability set; constructing a loss function according to service input data, adaptation layer parameter and actual service data of AI atomized capabilities in each AI atomized capability set; with a goal of minimizing the loss function, optimizing the adaptation layer parameter of at least one AI atomized capability set to determine the target AI atomized capability set.

Here, the service input data and the actual service data are provided by developers, and the adaptation layer parameter of each AI atomized capability is determined when the AI atomized capability is obtained by reconstruction.

Here, the service requirement is expressed as mathematical problems, and the determination of the target AI atomized capability set is treated as an optimization problem. Specifically, after a service requirement S is queried through the knowledge base or expert analysis or service intent analysis, an AI atomized capability type sequence of the service requirement S is determined, and the capability database is queried based on the AI atomized capability type sequence to determine at least one AI atomized capability set, which is expressed as (mₜ_{₁}, mₜ_{₂}, . . . , mₜ_{ₖ}), where mₜ_{ₖ} represents the AI atomized capability of k-th type, and each mₜ_{ₖ} can be provided by at least one capability provider.

The service requirement S is expressed as a mathematical problem, which is defined as a mathematical expression f(X, W) of end-to-end service. f(X, W) is a comprehensive expression of service outputs resulting from service data processing through multiple AI atomized capabilities, and can reflect a comprehensive service indicator.

X is the service input data, including all input data in the service process, which can be expressed as X=(X₁, X₂, . . . , Xₖ) according to k AI atomized capability type sequences. It is to be noted that input of the i-th AI atomized capability may be output of a previous AI atomized capability; in this case, Xₜ can be empty.

W is an adaptation layer parameter of k AI atomized capabilities, expressed as W=(W₁, W₂, . . . , Wₖ), where Wₖ represents an adaptation layer parameter of the k-th AI atomized capability.

It is assumed that the service demand S is the network complaint self-service robot service, and its comprehensive service indicator is user complaint satisfaction, which can be specifically expressed as: f(X, W)=a₁g₁(O₁)+a₂g₂(O₂)+ . . . +a₁₂g₁₂(O₁₂), where a₁ . . . a₂ represent weighted weights, a1+a2+ . . . +a12=1; gᵢ represents a performance indicator of the i-th AI atomized capability; and Oᵢ represents input of the i-th AI atomized capability. That is, the comprehensive service indicator is a certain weighted transformation of target output of each AI atomized capability.

After determining the mathematical expression f(X, W) of the AI atomized capability type sequence, to-be-optimized loss function L(f(X, W), Y) is defined based on the service performance indicator, where Y is the real service data, and L(f(X, W), Y) expresses a gap between predicted service data f(X, W) and the real service data. Taking the network complaint self-service robot service as an example, Y is satisfaction of real feedback from users.

After defining the service loss function L(f(X, W), Y), the problem that needs to be solved is to find the optimal adaptation layer parameter W=(W₁, W₂, . . . , Wₖ) to minimize the service loss function L(f(X, W), Y), that is, to solve the following optimization problem:

$${min}_{( {W}_{1} , {W}_{2} , … , {W}_{k} )} L ( f ( X , W ) , Y ) .$$

Traditional machine learning or deep learning methods can be used to solve the above optimization problem to obtain the adaptation layer parameters

$$( {W}_{1}^{*} , {W}_{2}^{*} , … , {W}_{k}^{*} ) .$$

of the optimal AI atomized capability set.

In this way, an AI atomized capability set that meet service requirement, can be obtained, with the AI atomized capability type sequence being (mₜ_{₁}, mₜ_{₂}, . . . , mₜ_{ₖ}), corresponding computing network resource requirement being (Gₜ_{₁}, Gₜ_{₂}, . . . , Gₜ_{ₖ}) and the adaptation layer parameter being

$$( {W}_{1}^{*} , {W}_{2}^{*} , … , {W}_{k}^{*} )$$

In actual application, considering that the same AI atomized capability is deployed on multiple nodes with different computing network resources, its processing effect will also be different (for example, if voice recognition capability is deployed on four nodes with different computing network resources, real-time performance of voice recognition will also be different). Therefore, based on location information of service data and computing network requirement in combination with computing network resources provided by each node in the actual network, screening (such as selecting a node location with optimal computing network resources according to real-time requirement of servicees, or dynamically adjusting node location) is performed to determine a suitable node to deploy each AI atomized capability within the AI atomized capability set, thereby adaptively building an end-to-end AI service application system.

Based on this, in some embodiments, the building an end-to-end AI service application according to the target AI atomized capability set, includes: determining a collection end of service data and a receiving end of a service data processing result; determining a data flow network transmission path from the collection end to the receiving end; based on the principle of fastest calculation, according to network node information and location information in the data flow network transmission path, determining a network node set required for deploying the target AI atomized capability set; deploying corresponding AI atomized capabilities on each network node in the network node set to build the end-to-end AI service application.

Here, the network node information may include computing resources provided by the network node.

Specifically, the building an end-to-end AI service application according to the target AI atomized capability set, includes: determining a location where a service data flow is generated, i.e., a collection end of service data; and determining a location for receiving a result of processing by the AI atomized capability set, i.e., a receiving end of a service data processing result.

The determining a data flow network transmission path from the collection end to the receiving end, includes: determining the network node information and location information of nodes passed through during transmission.

On the data flow transmission path, based on the principle of fastest calculation, the network node information and location information in the data flow transmission path are used as input, and a path optimization algorithm (such as the nearest neighbor principle) is used in combination with a dynamic programming method to calculate and obtain the optimal network node path. It is to be noted that AI atomized capabilities have been deployed in advance on computing nodes or network nodes that meet the computing network resource requirements.

At this point, the AI atomized capability set and the optimal computing network nodes

$$( {C}_{{t}_{1}}^{{1}_{1}} , {C}_{{t}_{2}}^{{1}_{2}} , … , {C}_{{t}_{k}}^{{1}_{k}} )$$

that meet service requirements, are determined, where tᵢ represents a type of an AI atomized capability, lᵢ represents a location of computing resources deployed for the AI atomized capability (that is, on which network node the AI atomized capability is deployed). Engineering methods can be used to connect the service data collection end, various AI atomized capabilities, and the service data result receiving end together to build an end-to-end AI application that meets service requirements.

Taking the network complaint self-service robot service as an example, the service data is user complaint voice and user network data. The location of user network data is relatively fixed, and the AI atomized capability for root cause analysis can be deployed with the network. While the user complaint voice data is collected and sent by the user's communication equipment, when the user complaint voice data is transmitted to the service system through the communication network, appropriate network nodes are sequentially addressed to perform computation of AI atomized capabilities such as speech recognition, entity word recognition, complaint summarization, etc., and feed computation results into the network node on which the AI atomized capability for root cause analysis is deployed, thereby ultimately completing the entire service process.

In actual application, the AI atomized capabilities can be dynamically adjusted based on the feedback data of end-to-end AI service application to obtain a better combination of AI atomized capabilities.

Based on this, in some embodiments, the service implementation method further includes: dynamically adjusting the adaptation layer parameter of the AI atomized capability and/or the AI model corresponding to the AI atomized capability according to feedback data of the end-to-end AI service application.

Specifically, the dynamically adjusting the adaptation layer parameter of the AI atomized capability and/or the AI model corresponding to the AI atomized capability according to feedback data of the end-to-end AI service application, includes: performing a first optimization operation on the end-to-end AI service application, where the first optimization operation is for the adaptation layer parameter of the AI atomized capability; performing a second optimization operation on the end-to-end AI service application, where the second optimization operation is for the AI model corresponding to the AI atomized capability.

Here, the optimization can be divided into two parts: one part is to optimize adaptation layers (that is, the adaptation part for applying the general model to different servicees) corresponding to relevant AI atomized capabilities in a service application according to a service goal; the other part is to optimize the single AI atomized capability that serves multiple servicees, according to service feedback data, that is, to optimize the general intelligent layer (that is, the general model part).

In some embodiments, performing a first optimization operation on the end-to-end AI service application includes: obtaining feedback data of the end-to-end AI service application, updating the loss function according to the feedback data and adaptation layer parameter; optimizing adaptation layer parameters for at least one AI atomized capability set with the goal of minimizing the updated loss function, and determining a new target AI atomized capability set. The feedback data includes: service indicator data directly fed back by users in the service system, and manually annotated data of service data.

For example, for the service requirement S is the network complaint self-service robot service system, the service indicator data is the user complaint satisfaction; the manually annotated data of service data may include: input of each AI atomized capability, which can be obtained by manually annotating the service data obtained during an entire service process of the network complaint self-service robot.

Specifically, when the end-to-end AI application is running, the service side can choose whether to feed back the received data to the system in a timely manner based on whether the service has the need for continuous optimization. If there is a need for continuous optimization, the system will perform large closed-loop optimization after receiving the service feedback data. The large closed-loop optimization mainly continuously optimizes the adaptation layers of AI atomized capabilities, so that service performance indicators are continuously improved.

Here, the new target AI atomized capability set can be determined by referring to the above method for determining the target AI atomized capability set required to achieve service requirements, which will not be repeated here.

In some embodiments, the target AI atomized capability set includes: at least one target AI atomized capability. The performing a second optimization operation on the end-to-end AI service application, includes: obtaining feedback data of the end-to-end AI service application, and optimizing the AI model corresponding to the at least one target AI atomized capability based on the feedback data.

Here, each AI atomized capability will support different service applications, and the feedback data collected by the system from service applications can be used for continuous optimization of a single AI atomized capability.

The relevant optimization process can be decomposed by experts based on feedback data to obtain training data for each AI model, and then utilize AI model training codes provided by the capability provider to adaptively perform continuous optimization (i.e., optimizing the general intelligent layer of AI atomized capabilities), thereby improving the performance of each AI atomized capability.

In some embodiments, the deploying corresponding AI atomized capabilities on at least one network node, includes: according to a preset deployment protocol, deploying corresponding AI atomized capabilities on each network node in a network node set; where the deployment protocol includes at least one of the following: a distribution protocol configured to indicate interactive operations between network nodes during the process of AI capability accessing the network; a security protocol configured to indicate encryption and decryption operations and/or protection operations between network nodes.

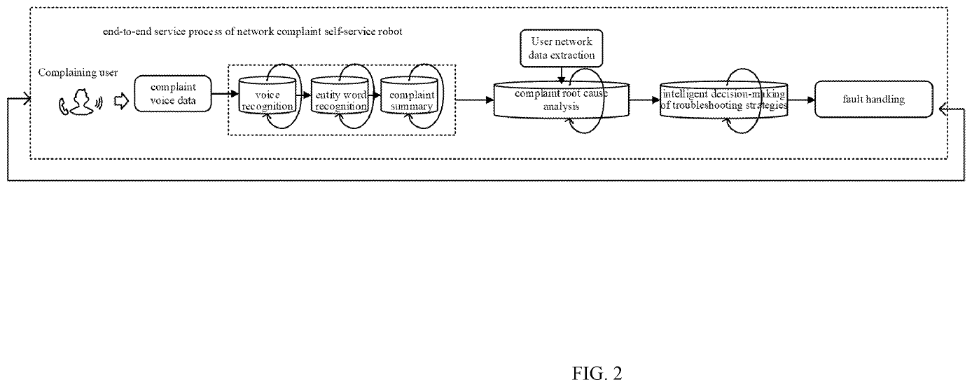

FIG. 2 is a schematic flow chart of an exemplary end-to-end service implementation method of a network complaint self-service robot according to an embodiment of the present disclosure. As shown in FIG. 2, in this service, the service party data includes user complaint voice data and user network data; AI capabilities include voice recognition, entity word recognition, complaint summary, complaint root cause analysis, intelligent decision-making of troubleshooting strategies, fault handling, etc., and a party that can provide one or more of the above AI atomized capabilities is a capability provider; an available AI computing power includes cloud, edge, and end computing power devices, such as cloud-based GPU services, edge all-in-one machines, user mobile terminals, network transmission equipment, etc., and a party that can provide one or more of these computing power devices is the computing power provider; the goal of the service is to quickly and accurately solve complaint problems for users, and the entire service relies on ubiquitous communication network connections to realize information flow.

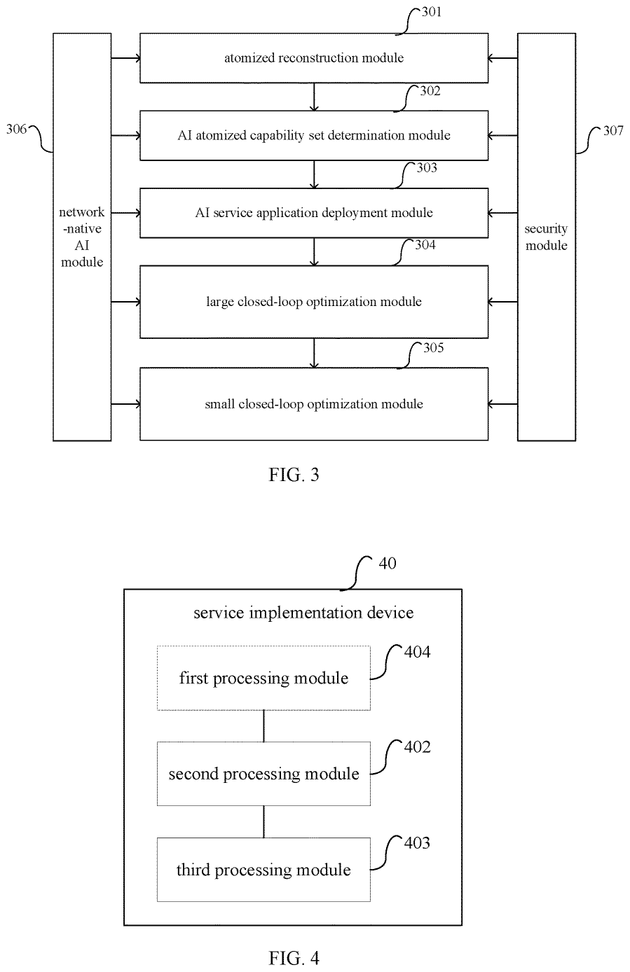

FIG. 3 is a schematic diagram of an exemplary holistic intelligent system according to an embodiment of the present disclosure. As shown in FIG. 3, the holistic intelligent system includes the following modules: an atomized reconstruction module 301, an AI atomized capability set determination module 302, an AI service application deployment module 303, a large closed-loop optimization module 304, and a small closed-loop optimization module 305.

The atomized reconstruction module 301 is configured to perform atomized reconstruction on AI capabilities connected to the holistic AI system, to reconstruct each AI capability into a combination of AI atomized capabilities; and generate a capability database based on the AI capabilities and a combination of AI atomized capabilities obtained via reconstruction.

The capability database includes: at least one AI capability and an AI atomized capability combination corresponding to each AI capability; the AI atomized capability combination includes one or more AI atomized capabilities and capability information corresponding to each AI atomized capability.

Here, the capability information may include: capability description information of AI atomized capability, computing network resource requirement, adaptation layer parameter, correspondence between adaptation layer parameter and computing network resource requirement, and an identifier of AI atomized capability.

Each AI atomized capability includes: a general intelligence layer, an adaptation layer, and an interface layer.

The AI atomized capability set determination module 302 is specifically configured to query a preset knowledge base according to a target service requirement to determine an AI atomized capability type sequence corresponding to the target service requirement; query a preset capability database according to the AI atomized capability type sequence to determine a target AI atomized capability set required to implement the service requirement.

Specifically, the AI atomized capability set determination module 302 is specifically configured to query the knowledge base according to the target service requirement to determine an AI atomized capability type sequence corresponding to the target service requirement; query the capability database according to the AI atomized capability type sequence to determine at least one AI atomized capability set; construct a loss function according to service input data, adaptation layer parameter and actual service data of AI atomized capabilities in each AI atomized capability set; with a goal of minimizing the loss function, optimize the adaptation layer parameter of at least one AI atomized capability set to determine the target AI atomized capability set.

The AI service application deployment module 303 is configured to build an end-to-end AI service application based on the target AI atomized capability set.

Specifically, the AI service application deployment module 303 is specifically configured to determine a collection end of service data and a receiving end of a service data processing result; determine a data flow network transmission path from the collection end to the receiving end; on the data flow transmission path, based on the principle of fastest calculation, with the network node information and location information in the data flow transmission path being used as input, calculate and obtain an optimal network node path by using a path optimization algorithm (such as the nearest neighbor principle) in combination with a dynamic programming method.

The large closed-loop optimization module 304 is configured to obtain feedback data of the service application, construct a loss function according to the feedback data and adaptation layer parameters; with a goal of minimizing the loss function, optimize the adaptation layer parameters of at least one AI atomized capability set to determine a new target AI atomized capability set.

The small closed-loop optimization module 305 is configured to obtain feedback data of the service application and optimize an AI model corresponding to at least one target AI atomized capability based on the feedback data.

The system further includes: a network-native AI module 306 configured to provide standards for AI capabilities in access networks, so that AI capabilities are accessed to the network with the same standards, making them sensing-capable, identifiable, routable, registrable, authenticatable, evaluable and measurable in the network, and automatically scalable based on network/computing resources.

The network-native AI module 306 further provides the following functions:
network management of AI capabilities, including network-access control, distribution, routing, and coordinated optimization and scheduling of computing or network resources, to achieve elastic, flexible and adaptive network resource control for differentiated AI services;
AI capability on-network computing management, which enables communication network equipment to perform AI computing while transmitting information, orchestrate and distribute AI components for end-to-end servicees in communication networks, and deploy AI components on demand based on computing resource characteristics (such as convolutional computing enhanced chips);
AI capability/computing/network integrated control, which integrates scheduling of AI capabilities, computing power, and communication networks to achieve flexible orchestration of end-to-end AI atomized capabilities based on user intent.

The system further includes: a security module 307 configured to provide secure and reliable evaluation technology and test access benchmarks under a holistic artificial intelligence framework, to ensure the security and reliability of each link under atomized reconstruction, end-to-end closed-loop optimization of service, and overall network-native holistic framework, thereby achieving traceability, mutual trust, auditability, and anti-attack of AI services.

The security module 307 may include: an AI computing power security module and an AI capability security module. The AI computing power security module 307 is configured to provide integrated protection for the network cloud edge AI computing power and establish an endogenous security protection mechanism. The AI capability security module includes model transparency and interpretability, lack of ethical bias, clear responsibilities, privacy security, etc. of the capability provider, as well as the compliance, controllable, measurable, and traceable use of AI capabilities by the capability user, and is configured to provide security for the entire process of service deployment, service usage information, and call process.

It is to be noted that the modules provided in the above embodiment and the embodiment of the method shown in FIG. 1 belong to the same concept, and the specific implementation process refers to the method embodiment, which will not be repeated here.

In the system provided in the embodiments of the present application, AI service demanders, AI capability providers, and general AI computing power providers are organically connected by a ubiquitous network through processes such as atomized reconstruction of AI capabilities, large closed-loop optimization of multi-capability combinations with service demand goals as optimization goals, and adaptive selection of computing network resources based on computing network requirements of capabilities. According to requirements of intelligent service, the connected AI capabilities are organized, scheduled, configured, and monitored on demand, so that the connected AI capabilities can operate and provide services safely, reliably, and controllably on the most reasonable computing network resources.

FIG. 4 is a schematic diagram of a service implementation device according to an embodiment of the present disclosure. As shown in FIG. 4, the service implementation device 40 includes:
a first processing module 401 configured to query a preset knowledge base according to a target service requirement to determine an AI atomized capability type sequence corresponding to the target service requirement;
a second processing module 402 configured to query a preset capability database according to the AI atomized capability type sequence to determine a target AI atomized capability set required to implement the service requirement;
a third processing module 403 configured to build an end-to-end AI service application according to the target AI atomized capability set.

It is to be noted that the service implementation device provided in the above embodiment only uses division of the above program modules as an example for implementing the corresponding service implementation method. In actual applications, the above processing can be assigned to different program modules as needed, that is, an internal structure of the smart device is divided into different program modules to complete all or part of the processing described above. In addition, the device provided in the above embodiment and the embodiment of the corresponding method belong to the same concept, and the specific implementation process is detailed in the method embodiment, which will not be repeated here.

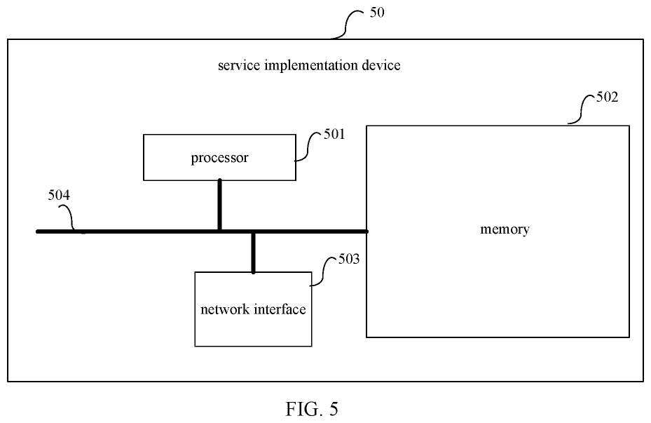

FIG. 5 is a schematic diagram of another service implementation device according to an embodiment of the present disclosure. As shown in FIG. 5, the service implementation device 50 includes a processor 501 and a memory 502 configured to store a computer program that can be run on the processor.

The processor 501 is configured to run a computer program to perform: querying a preset knowledge base according to a target service requirement to determine an AI atomized capability type sequence corresponding to the target service requirement; querying a preset capability database according to the AI atomized capability type sequence to determine a target AI atomized capability set required to implement the service requirement; building an end-to-end AI service application based on the target AI atomized capability set. Specifically, the service implementation device can also execute the method shown in FIG. 1, and belongs to the same concept as the service implementation method embodiment shown in FIG. 1. The specific implementation process refers to the method embodiment, which will not be repeated here.

In actual application, the service implementation device 50 may further include: at least one network interface 503. The various components in the service implementation device 50 are coupled together through a bus system 504. It can be understood that the bus system 504 is configured to realize connection and communication between these components. In addition to the data bus, the bus system 504 also includes a power bus, a control bus and a status signal bus. However, for the sake of clarity, various buses are marked as bus systems 504 in FIG. 5. There may be at least one processor 501. The network interface 503 is configured for wired or wireless communication between the service implementation device 50 and other devices.

The memory 502 in the embodiment of the present disclosure is configured to store various types of data to support the operation of the service implementation device 50.

The method disclosed in the above embodiment of the present disclosure can be applied to the processor 501, or implemented by the processor 501. The processor 501 may be an integrated circuit chip with signal processing capabilities. In the implementation process, each step of the above method can be completed by the hardware integrated logic circuit in the processor 501 or the instruction in the form of software. The above processor 501 can be a general processor, a digital signal processor (DSP), or other programmable logic devices, discrete gates or transistor logic devices, discrete hardware components, etc. The processor 501 can implement or execute the methods, steps and logic block diagrams disclosed in the embodiment of the present disclosure. The general processor can be a microprocessor or any conventional processor, etc. The steps of the method disclosed in the embodiment of the present disclosure can be executed directly by a hardware decoding processor, or by a combination of the hardware and software modules in the decoding processor. The software module can be located in a storage medium, which is located in the memory 502. The processor 501 reads information in the memory 502 and completes the steps of the above method in combination with its hardware.

In an exemplary embodiment, the service implementation device 50 can be implemented by one or more application-specific integrated circuits (ASICs), DSPs, programmable logic devices (PLDs), complex programmable logic devices (CPLDs), field-programmable gate arrays (FPGAs), general-purpose processors, controllers, microcontrollers (MCUs), microprocessors, or other electronic components, and configured to execute the aforementioned method.

One embodiment of the present disclosure further provides a computer-readable storage medium on which a computer program is stored. When the computer program, when executed by a processor, causes the processor to perform: querying a preset knowledge base according to a target service requirement to determine an AI atomized capability type sequence corresponding to the target service requirement; querying a preset capability database according to the AI atomized capability type sequence to determine a target AI atomized capability set required to implement the service requirement; building an end-to-end AI service application based on the target AI atomized capability set. Specifically, the computer program can also execute the method shown in FIG. 1, and belongs to the same concept as the service implementation method embodiment shown in FIG. 1. The specific implementation process refers to the method embodiment, which will not be repeated here.

In the several embodiments provided in the present application, it should be understood that the disclosed device and method can be implemented in other ways. The device embodiments described above are only schematic. For example, the division of units is only a logical function division. There may be other division methods in actual implementation, for example, multiple units or components can be combined, or can be integrated into another system, or some features can be ignored, or not executed. In addition, coupling, direct coupling, or communication connection between components shown or discussed can be through some interfaces, and indirect coupling or communication connection of device or unit can be electrical, mechanical or other forms.

The units described above as separate components may or may not be physically separated, and components displayed as units may or may not be physical units, that is, they may be located in one place or distributed on multiple network units; some or all of the units may be selected according to actual needs to achieve the purpose of the present embodiment.

In addition, various functional units in the embodiments of the present disclosure may be integrated into one processing unit, or each unit may be separately used as a unit, or two or more units may be integrated into one unit; the above integrated units may be implemented in the form of hardware or in the form of hardware plus software functional units.

Those skilled in the art can understand that all or part of the steps of implementing the above method embodiments can be completed by a program instructing related hardware. The aforementioned program can be stored in a computer-readable storage medium. When the program is executed, the steps of the above method embodiments can be executed. The aforementioned storage medium includes: mobile storage device, read-only memory (ROM), random access memory (RAM), disk or optical disk, etc., and other media capable of storing program codes.

Alternatively, if the above integrated unit of the present disclosure is implemented in the form of a software function module and sold or used as an independent product, it can also be stored in a computer-readable storage medium. Based on this understanding, the essence of the technical solution of the present disclosure or the part that contributes to the related art or the part of the technical solution may be embodied in the form of a software product. The computer software product is stored in a storage medium, includes several instructions which enables a computer device (which may be a personal computer, a server, or a network device, etc.) to execute all or part of the steps of the methods described in various embodiments of the present disclosure. The foregoing storage medium includes various media capable of storing program codes such as mobile storage devices, ROM, RAM, disk, optical disc.

It should be noted that: “first”, “second”, etc. are used to distinguish similar objects, and are not necessarily used to describe a specific order or sequence.

In addition, the technical solutions described in the embodiments of the present application can be combined arbitrarily without conflict.

The above is only a specific embodiment of the present disclosure, but the protection scope of the present disclosure is not limited thereto. Any person skilled in the art who is familiar with the technical field can easily think of changes or substitutions within the technical scope disclosed by the present disclosure, which should be included in the protection scope of the present disclosure. Therefore, the protection scope of the present disclosure should be based on the protection scope of the claims.

1. A service implementation method, comprising:
querying a preset knowledge base according to a target service requirement to determine an artificial intelligence (AI) atomized capability type sequence corresponding to the target service requirement;
querying a preset capability database according to the AI atomized capability type sequence to determine a target AI atomized capability set required to implement the service requirement; and
building an end-to-end AI service application based on the target AI atomized capability set.

2. The method according to claim 1, wherein the method further includes:
obtaining at least one AI atomized capability corresponding to each AI capability in at least one AI capability; wherein the at least one AI atomized capability corresponding to each AI capability is obtained by reconstructing the AI capability; and
constructing a capability database according to the at least one AI atomized capability corresponding to each AI capability.

3. The method according to claim 2, wherein the reconstructing the AI capability, includes at least one of the following:
decomposing the AI capability into a combination of AI atomized capabilities, and determining a general intelligence layer, adaptation layer, interface layer and capability information included in each AI atomized capability; wherein the capability information at least includes an adaptation layer parameter; or,
decomposing computing network resources required for the AI capability, determining a computing network resource requirement corresponding to each AI atomized capability, and establishing correspondence between the adaptation layer parameter of each AI atomized capability and the computing network resource requirement.

4. The method according to claim 1, wherein the querying a preset capability database according to the AI atomized capability type sequence to determine a target AI atomized capability set required to implement the service requirement, includes:
querying the capability database according to the AI atomized capability type sequence to determine at least one AI atomized capability set; constructing a loss function according to service input data, adaptation layer parameter and actual service data of AI atomized capabilities in each AI atomized capability set; and
with a goal of minimizing the loss function, optimizing the adaptation layer parameters of at least one AI atomized capability set to determine the target AI atomized capability set.

5. The method according to claim 1, wherein the building an end-to-end AI service application based on the target AI atomized capability set, includes:
determining a collection end of service data and a receiving end of a service data processing result;
determining a data flow network transmission path from the collection end to the receiving end;
based on a principle of fastest calculation, according to network node information and location information in the data flow network transmission path, determining a network node set required for deploying the target AI atomized capability set; and
deploying corresponding AI atomized capabilities on each network node in the network node set to build the end-to-end AI service application.

6. The method according to claim 1, wherein the method further includes:
according to feedback data of the end-to-end AI service application, dynamically adjusting the adaptation layer parameter of the AI atomized capability and/or an AI model corresponding to the AI atomized capability.

7. The method according to claim 6, wherein according to feedback data of the end-to-end AI service application, dynamically adjusting the adaptation layer parameter of the AI atomized capability, includes:
obtaining feedback data of the end-to-end AI service application, updating the loss function according to the feedback data and the adaptation layer parameter; wherein the feedback data includes service input data and user feedback service data; and
optimizing adaptation layer parameters for at least one AI atomized capability set with the goal of minimizing the updated loss function, and determining a new target AI atomized capability set.

8. The method according to claim 6, wherein according to feedback data of the end-to-end AI service application, dynamically adjusting an AI model corresponding to the AI atomized capability, includes:
obtaining feedback data of the end-to-end AI service application, and optimizing the AI model corresponding to at least one target AI atomized capability according to the feedback data.

9. The method according to claim 5, wherein the deploying corresponding AI atomized capabilities on each network node in the network node set, includes:
according to a preset deployment protocol, deploying corresponding AI atomized capabilities on each network node in the network node set; wherein the deployment protocol includes at least one of the following:
a distribution protocol configured to indicate interactive operations between network nodes during a process of the AI capability accessing the network; and
a security protocol configured to indicate encryption and decryption operations and/or protection operations between network nodes.

10. (canceled)

11. A service implementation device, comprising: a memory, a processor and a computer program stored in the memory and executable on the processor; wherein the processor, when executing the program, performs;
querying a preset knowledge base according to a target service requirement to determine an artificial intelligence (AI) atomized capability type sequence corresponding to the target service requirement;
querying a preset capability database according to the AI atomized capability type sequence to determine a target AI atomized capability set required to implement the service requirement; and
building an end-to-end AI service application based on the target AI atomized capability set.

12. A computer-readable storage medium, comprising a computer program stored thereon; wherein the computer program, when executed by a processor, causes the processor to perform;
querying a preset knowledge base according to a target service requirement to determine an artificial intelligence (AI) atomized capability type sequence corresponding to the target service requirement;
querying a preset capability database according to the AI atomized capability type sequence to determine a target AI atomized capability set required to implement the service requirement; and
building an end-to-end AI service application based on the target AI atomized capability set.

13. The service implementation device according to claim 11, wherein the processor, when executing the program, further performs:
obtaining at least one AI atomized capability corresponding to each AI capability in at least one AI capability; wherein the at least one AI atomized capability corresponding to each AI capability is obtained by reconstructing the AI capability; and
constructing a capability database according to the at least one AI atomized capability corresponding to each AI capability.

14. The service implementation device according to claim 13, wherein when reconstructing the AI capability, the processor, when executing the program, performs at least one of the following:
decomposing the AI capability into a combination of AI atomized capabilities, and determining a general intelligence layer, adaptation layer, interface layer and capability information included in each AI atomized capability; wherein the capability information at least includes an adaptation layer parameter; or,
decomposing computing network resources required for the AI capability, determining a computing network resource requirement corresponding to each AI atomized capability, and establishing correspondence between the adaptation layer parameter of each AI atomized capability and the computing network resource requirement.

15. The service implementation device according to claim 11, wherein when querying a preset capability database according to the AI atomized capability type sequence to determine a target AI atomized capability set required to implement the service requirement, the processor, when executing the program, performs:
querying the capability database according to the AI atomized capability type sequence to determine at least one AI atomized capability set; constructing a loss function according to service input data, adaptation layer parameter and actual service data of AI atomized capabilities in each AI atomized capability set; and
with a goal of minimizing the loss function, optimizing the adaptation layer parameters of at least one AI atomized capability set to determine the target AI atomized capability set.

16. The service implementation device according to claim 11, wherein when building an end-to-end AI service application based on the target AI atomized capability set, the processor, when executing the program, performs:
determining a collection end of service data and a receiving end of a service data processing result;
determining a data flow network transmission path from the collection end to the receiving end;
based on a principle of fastest calculation, according to network node information and location information in the data flow network transmission path, determining a network node set required for deploying the target AI atomized capability set; and
deploying corresponding AI atomized capabilities on each network node in the network node set to build the end-to-end AI service application.

17. The service implementation device according to claim 11, wherein the processor, when executing the program, further performs:
according to feedback data of the end-to-end AI service application, dynamically adjusting the adaptation layer parameter of the AI atomized capability and/or an AI model corresponding to the AI atomized capability.

18. The service implementation device according to claim 17, wherein when dynamically adjusting the adaptation layer parameter of the AI atomized capability according to feedback data of the end-to-end AI service application, the processor, when executing the program, performs:
obtaining feedback data of the end-to-end AI service application, updating the loss function according to the feedback data and the adaptation layer parameter; wherein the feedback data includes service input data and user feedback service data; and
optimizing adaptation layer parameters for at least one AI atomized capability set with the goal of minimizing the updated loss function, and determining a new target AI atomized capability set.

19. The service implementation device according to claim 17, wherein when dynamically adjusting an AI model corresponding to the AI atomized capability according to feedback data of the end-to-end AI service application, the processor, when executing the program, performs:
obtaining feedback data of the end-to-end AI service application, and optimizing the AI model corresponding to at least one target AI atomized capability according to the feedback data.

20. The service implementation device according to claim 16, wherein when deploying corresponding AI atomized capabilities on each network node in the network node set, the processor, when executing the program, performs:
according to a preset deployment protocol, deploying corresponding AI atomized capabilities on each network node in the network node set; wherein the deployment protocol includes at least one of the following:
a distribution protocol configured to indicate interactive operations between network nodes during a process of the AI capability accessing the network; and
a security protocol configured to indicate encryption and decryption operations and/or protection operations between network nodes.

21. The computer-readable storage medium according to claim 12, wherein the computer program, when executed by the processor, causes the processor to further perform:
obtaining at least one AI atomized capability corresponding to each AI capability in at least one AI capability; wherein the at least one AI atomized capability corresponding to each AI capability is obtained by reconstructing the AI capability; and
constructing a capability database according to the at least one AI atomized capability corresponding to each AI capability.
